(19) United States
(12) Patent Application Publication
(10) Pub. No.: US 2026/0169512 A1
(43) Pub. Date: Jun. 18, 2026

(54) POWER REGULATOR FOR DIGITAL CIRCUITRY

(71) Applicant: Arm Limited, Cambridge (GB)

(72) Inventors: Rainer HERBERHOLZ, Great Abington (GB); El Mehdi BOUJAMAA, Valbonne (FR); Stuart James AITKEN, Cambridge (GB)

(21) Appl. No.: 18/982,318

(22) Filed: Dec. 16, 2024

(51) Int. Cl. G05F 1/613; H02M 3/158

(52) U.S. Cl. CPC G05F 1/613; H02M 3/158

(57) ABSTRACT

An apparatus for controlling the voltage supply of one or more digital circuits, the one or more digital circuits having a functional clock unit to provide a clock signal to the one or more digital circuits, the apparatus including: a first feedback generation unit to generate a first feedback signal based on a comparison between a current number of gate delays corresponding to a current clock signal and a target number of gate delays; and a power regulator unit to adjust the power delivery to the one or more digital circuits based on the first feedback signal.

### FIELD

The present technology relates to controlling or regulating a supply voltage to a digital circuitry.

### BACKGROUND

Power delivery to digital circuits, such as those inside a data processor (e.g. a CPU or a GPU), is typically controlled or regulated based on a target voltage. A dedicated power regulator/control unit for a digital circuit controls the supply voltage (Vdd_L) of the digital circuit. Typically, an analogue control loop compares the supply voltage with a reference voltage (Vdd_REF) to generate a feedback signal. This feedback signal is then used to regulate the supply voltage accordingly.

Such a control loop that converts an analogue (voltage) measurement to a digital signal in order to generate digital feedback for the power regulator unit is inefficient. Moreover, digital circuits in existing processors are capable of operating at microsecond timescales and as such it is desirable to provide power regulator units with the capability to respond to changes in power delivery demands at (to have a loop bandwidth of) MHz frequency. Further, the Applicant recognized that there may be other factors, such as the operating temperature and the level of deterioration of the system, that can influence the power delivery requirement of a digital circuit (e.g. in a processor) beyond a simple voltage comparison.

There is, therefore, scope for improved apparatuses and methods for regulating power delivery for digital circuitry.

### BRIEF DESCRIPTION OF THE DRAWINGS

Embodiments will now be described, with reference to the accompanying drawings, in which:

FIG. 1 shows schematically an exemplary configuration of a digital circuit control loop according to an embodiment;

FIG. 2 shows schematically an exemplary configuration of a digital circuit control loop according to another embodiment;

FIG. 3 shows a flow diagram of an exemplary method of regulating the operation of a digital circuit according to an embodiment; and

FIG. 4 shows an exemplary circuit for a digital comparator.

### DETAILED DESCRIPTION

Developments in digital processing technology have enabled present digital systems to operate at μs-scale. The capacity to respond to fluctuations in power demands at μs-scale is therefore desirable. In existing digital systems, an analogue signal based on a voltage is used for the regulation of power delivery, and the need to convert the analogue signal to a digital one to generate a feedback signal reduces efficiency. Moreover, a feedback loop based on voltage signals does not account for other factors that influence the supply voltage required for of a digital system to operate at a particular clock frequency, such as the ambient and operating temperatures or the age of the system. The present technology thus proposes an approach to power delivery regulation capable of responding in less than a microsecond and capable of accounting for more than one factors that influence the supply voltage requirement of a digital system.

The present technology provides improved apparatuses and methods for regulating and controlling power delivery for digital systems. In particular, the present approach uses a digital feedback signal derived from the functional clock for a digital system instead of an analogue feedback signal based on voltage.

In various embodiments, a digital circuitry or digital system, e.g. in a data processor, may include one or more digital circuits, which may comprise, amongst other things, one or more processing cores or processing units and a functional clock that provides a clock signal to synchronize the actions of the digital circuits. The digital circuitry/system is typically powered by a power stage that comprises a power supply circuitry and regulated by a power regulator unit. The present approach controls and regulates the operation of the digital circuitry using feedback generated based on the clock signal of the digital circuitry instead of a supply voltage. Thus, embodiments herein provide improved response speed for power delivery regulation that is capable of accounting for more than one factor.

An aspect of the present technology thus provides an apparatus for controlling power delivery to one or more digital circuits, the one or more digital circuits having a functional clock unit to provide a clock signal to the one or more digital circuits, the apparatus comprising: a first feedback generation unit to generate a first feedback signal based on a comparison between a current number of gate delays corresponding to a current clock signal and a target number of gate delays; and a power regulator unit to adjust the power delivery to the one or more digital circuits based on the first feedback signal.

According to embodiments of the present technology, the number of gate delays corresponding to the clock signal of the functional clock is used to generate a feedback signal for regulating power delivery to the digital circuits. In other words, digital signals are used as input to generate the feedback instead of analogue signals (voltage). Since digital signals are generally more robust against electrical interference compared to analogue signals, by using digital inputs to generate feedback signals, noise and distortions may be reduced, and power delivery regulation may be performed with improved accuracy. Moreover, the voltage required by the digital circuits in order to perform at a particular speed may depend on a number of factors, such as the operating temperature and the age (and therefore efficiency) of the system, etc. By regulating power delivery based directly on the current number of gate delays at which the digital circuits operate, it is possible to account for multiple factors that influence the operation of the system to enable more effective power delivery and facilitate improved system performance.

In some embodiments, the first feedback signal may represent a difference between the current number of gate delays and the target number of gate delays, and the power regulator unit may be configured to adjust the power delivery to the one or more digital circuits to minimize the difference.

In some embodiments, the power regulator unit may adjust the power delivery to the one or more digital circuits to minimize the difference by increasing the power delivery to the one or more digital circuits when the current number of gate delays is lower than the target number of gate delays, and decreasing the power delivery to the one or more digital circuits when the current number of gate delays is higher than the target number of gate delays.

In some embodiments, the apparatus may further comprise a second feedback generation unit to generate a second feedback signal based on a comparison between a supply voltage of the one or more digital circuits and a reference voltage.

In some embodiments, upon startup of the digital circuits, the power regulator unit may be configured to adjust the power delivery to the one or more digital circuits based on the second feedback signal.

In some embodiments, the power regulator unit may be configured to adjust the power delivery to the one or more digital circuits based on the second feedback signal by increasing the power delivery to the one or more digital circuits until the current supply voltage of the one or more digital circuits reaches a predetermined fraction of the reference voltage.

In some embodiments, upon the current supply voltage reaching the predetermined fraction of the reference voltage, the power regulator unit may be configured to switch from the second feedback signal to the first feedback signal.

Another aspect of the present technology provides a computer-implemented method of controlling power delivery to one or more digital circuits, the one or more digital circuits having a functional clock unit to provide a clock signal to the one or more digital circuits, the method comprising: generating a first feedback signal based on a comparison between a current number of gate delays corresponding to a current clock signal and a target number of gate delays; and adjusting the power delivery to the one or more digital circuits based on the first feedback signal.

In some embodiments, the first feedback signal may represent a difference between the current number of gate delays and the target number of gate delays, and the power delivery to the one or more digital circuits may be adjusted to minimize the difference.

In some embodiments, the power delivery to the digital circuits may be adjusted to minimize the difference by increasing the power delivery to the one or more digital circuits when the current number of gate delays is lower than the target number of gate delays, and decreasing the power delivery to the one or more digital circuits when the current number of gate delays is higher than the target number of gate delays.

In some embodiments, the method may further comprise generating a second feedback signal based on a comparison between a current supply voltage of the one or more digital circuits and a reference voltage.

In some embodiments, the method may further comprise, upon startup of the one or more digital circuits, adjusting the power delivery to the one or more digital circuits based on the second feedback signal.

In some embodiments, the power delivery to the one or more digital circuits may be adjusted based on the second feedback signal by increasing the power delivery to the digital circuits until the current supply voltage of the one or more digital circuits reaches a predetermined fraction of the reference voltage.

In some embodiments, the method may further comprise, upon the current supply voltage reaching the predetermined fraction of the reference voltage, switching from the second feedback signal to the first feedback signal.

A further aspect of the present technology provides a system comprising: a system on chip comprising one or more digital circuits and a functional clock unit to provide a clock signal to the one or more digital circuits; a power stage comprising a power supply circuit to process power delivery to the system on chip; a first feedback generation unit to generate a first feedback signal based on a comparison between a current number of gate delays corresponding to a current clock signal and a target number of gate delays; and a power regulator unit to adjust the power delivery to the one or more digital circuits based on the first feedback signal.

In some embodiments, the system on chip may comprise the first feedback generation unit and the power regulator unit.

In some embodiments, the system on chip may comprise the first feedback generation unit, and the power stage may comprise the power regulator unit.

In some embodiments, the first feedback generation unit may be a time-to-digital converter.

In some embodiments, the system on chip may further comprise a second feedback generation unit to generate a second feedback signal based on a comparison between a current supply voltage of the digital circuits and a reference voltage.

In some embodiments, the second feedback generation unit may be a digital comparator, an analogue-to-digital converter, one or more pairs of ring oscillators, or a combination thereof.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

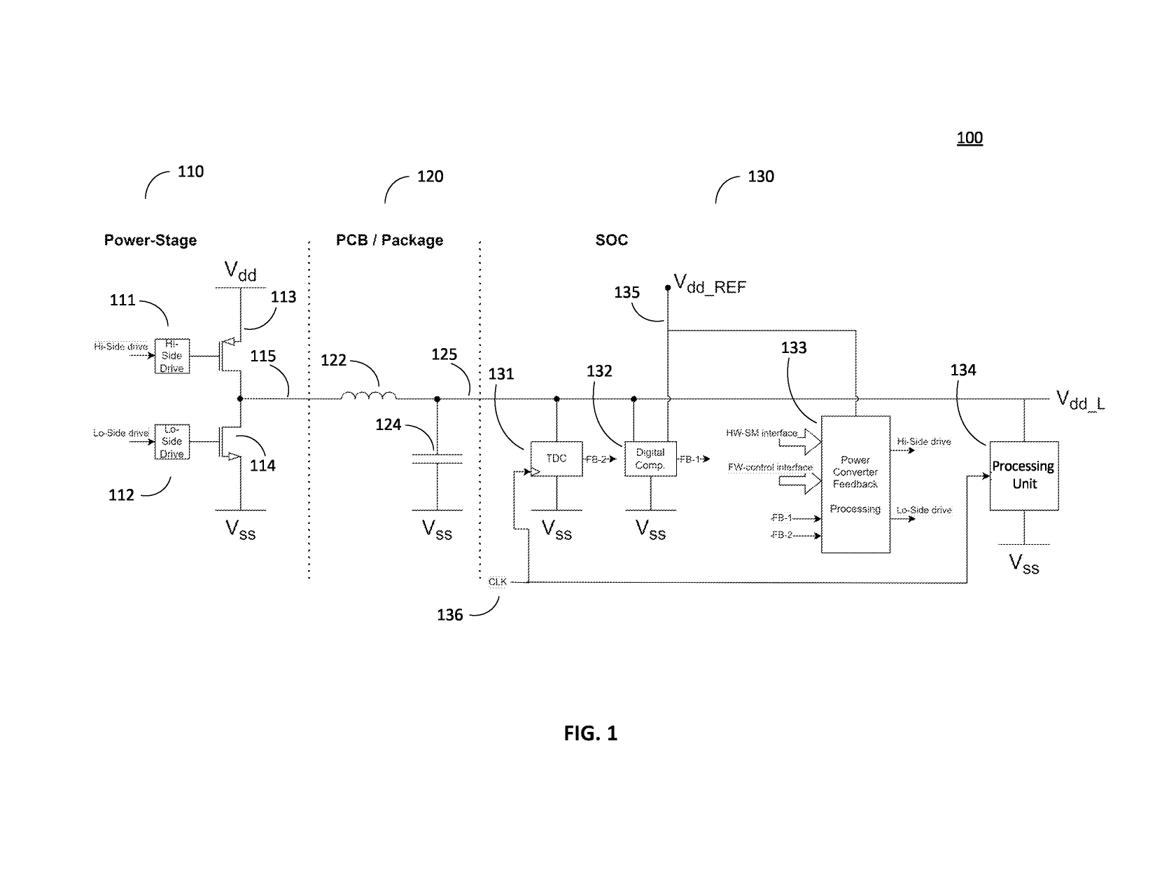

FIG. 1 schematically illustrates an exemplary implementation of a digital system 100 comprising an apparatus for controlling or regulating the operation of a digital circuit according to an embodiment. The digital system 100 comprises a power stage 110, a PCB/package 120 and a system on chip 130.

The power stage 110 comprises a high-side drive 111 and an associated high-side switching transistor 113 and a low-side drive 112 an associated low-side switching transistor 114, that altogether forms the switching stage of a buck converter. High-side drive 111 is a driver for high-side switching transistor 113, while low-side drive 112 is a driver for low-side switching transistor 114. The output of the power stage 115 is filtered by an inductor–capacitor filter 122, 124 to form a first supply rail 125. The duty cycle of the high-side drive and low-side drive control signals is controlled by a power regulator unit 133.

At the system on chip 130 side, a second supply rail 135 supplies a reference voltage Vdd_REF, which is set to a predetermined target value. The predetermined target value or the reference voltage Vdd_REF may either be a fixed value or a variable value that is under independent control separate from the power regulator unit 133 (e.g. SRAM bitcell rail). The system on chip 130 comprises a system clock (functional clock) 136 that generates a clock signal for synchronising and coordinating the operations or actions of components of the SoC 130, including one or more processing unit 134 that performs data processing, for example.

The system on chip 130 also comprises a first feedback generation unit 131 in the form of a time-digital converter (TDC) that generates and outputs a (digital) feedback signal FB-2 (first feedback signal) based on the clock signal of the system clock 136, and a second feedback generation unit 132 in the form of a digital comparator that compares the voltage received on the first supply rail 125 with the reference voltage Vdd_REF received on the second supply rail 135, and outputs a (digital) feedback signal FB-1 (second feedback signal). It should be noted that, in other embodiments, the first feedback generation unit 131 may be implemented using a functional equivalence of a TDC, and, similarly, the second feedback generation unit 132 may be implemented using a functional equivalence of a digital comparator.

Further, the SoC 130 comprises a power regulator unit 133 that receives the feedback signal FB-2 and/or the feedback signal FB-1 and, based on the feedback signal FB-2 and/or the feedback signal FB-1, performs control processing to output control signals (Hi-side drive, Lo-side drive) to the high-side drive 111 and low-side drive 112 to dynamically regulate (adjust) the voltage of the first supply rail 125.

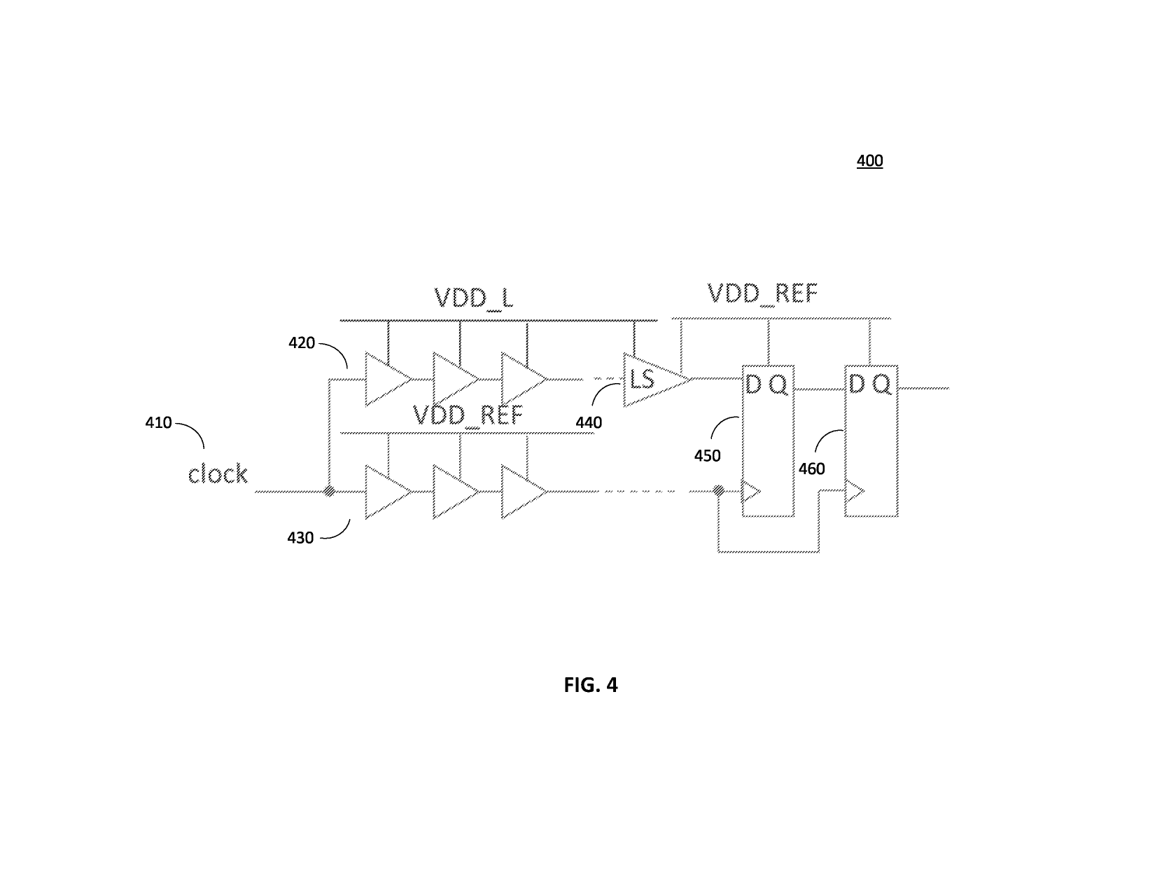

There are multiple ways of implementing a digital comparator, e.g. using ring oscillators. An exemplary circuit of a digital comparator 400 is shown in FIG. 4. A clock 410 is provided to two sets of sequential buffers 420, 430, respectively on the supply to be controlled (VDD_L) and on the reference supply (VDD_REF). The relative speed of propagation through the buffers depends primarily on the difference between the two voltages. When VDD_L is less than VDD_REF, the VDD_REF clock pulse arrives at a D-type flip-flop 450 before the VDD_L clock pulse (which goes through a level shifter 440), and the flip-flop 450 outputs 0. When VDD_L is greater than VDD_REF, the VDD_L clock pulse arrives first, and the flip-flop 450 outputs 1. A second flip-flop 460 may be included for metastability reasons.

In some embodiments, the first feedback generation unit 131 and the second feedback generation unit 132 (e.g. the TDC and the digital comparator) may be integrated into a single feedback generation unit that performs both functions, if desired.

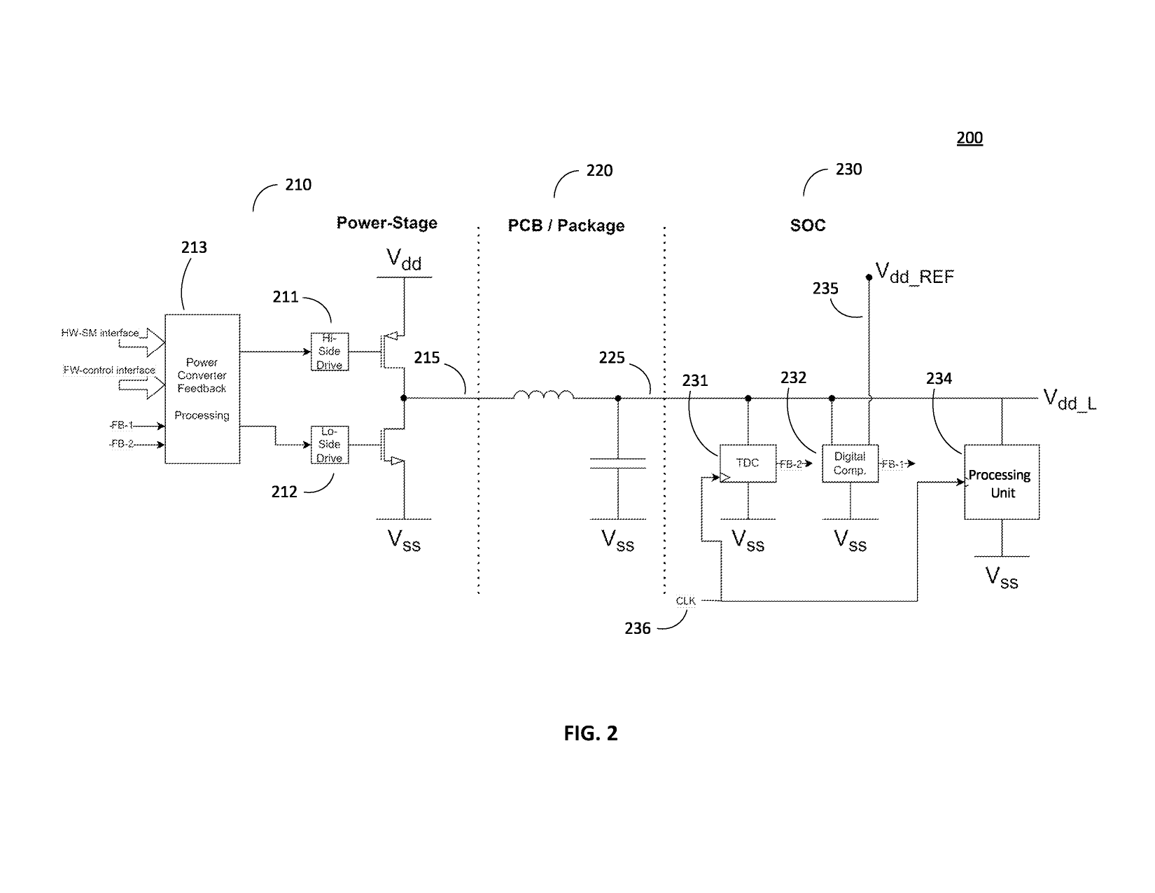

An alternative embodiment is shown in FIG. 2, which schematically illustrates another exemplary implementation of a digital system 200 comprising a power delivery regulation apparatus. The digital system 200 is similar to the digital system 100, and comprises a power stage 210, a PCB/package 220 and a system on chip 230.

The power stage 210 comprises a high-side drive 211 and a low-side drive 212, which together supply power to the SoC 230 via a first supply rail 215.

At the SoC 230 side, a second supply rail 235 supplies a reference voltage Vdd_REF. The SoC 230 comprises a system clock (functional clock) 236 that generates a clock signal for synchronising and coordinating the operations or actions of components of the SoC 230, including one or more processing unit 234 that performs data processing, for example. The SoC 230 also comprises a first feedback generation unit 231 that generates and outputs a (digital) feedback signal FB-2 (first feedback signal) based on the clock signal of the system clock 236, similar to the first feedback generation unit 131, and a second feedback generation unit 232 that compares the voltage received on the first supply rail 213 with the reference voltage Vdd_REF received on the second supply rail 235, and outputs a (digital) feedback signal FB-1 (second feedback signal), similar to the second feedback generation unit 231.

The difference between the digital system 200 and the digital system 100 is that a power regulator unit 213 is disposed at the power stage 210 instead of the SoC 230. However, the power regulator unit 213 functions in substantially the same way as the power regulator unit 133, which receives the feedback signal FB-2 and/or the feedback signal FB-1 and, based on the feedback signal FB-2 and/or the feedback signal FB-1, performs control processing to output control signals (Hi-side drive, Lo-side drive) to the high-side drive 211 and low-side drive 212 to dynamically regulate (adjust) the voltage of the first supply rail 225.

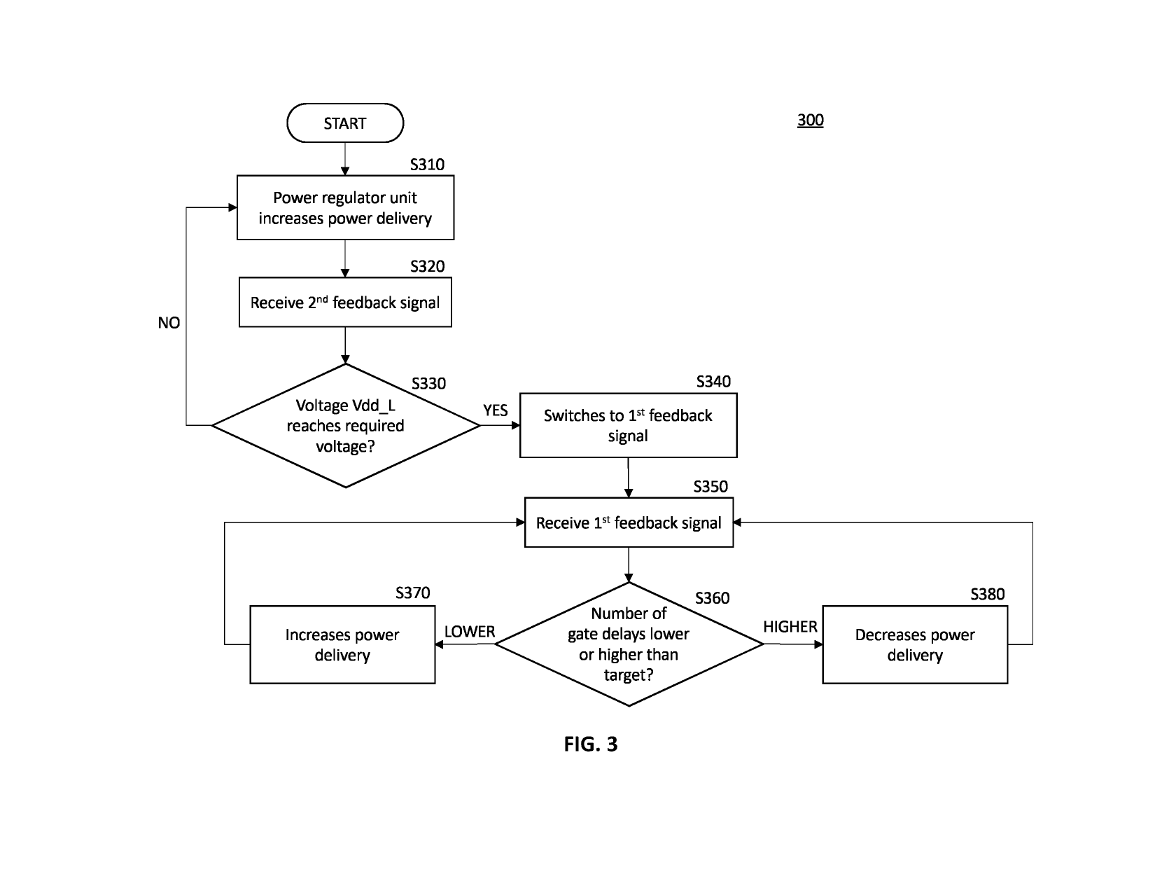

An exemplary method of controlling or regulating the operation of a digital system comprising one or more digital circuits, such as the digital system 100 or the digital system 200, is illustrated in the flow diagram of FIG. 3.

At system start up (“START”), the power regulator unit 133, 213 controls the high-side drive 111, 211 and the low-side drive 112, 212 to increase power delivery along the first supply rail 125, 225 to the SoC 130, 230 at S310. The second feedback generation unit 132, 232 compares the voltage Vdd_L on the first supply rail 125, 225 with the reference voltage Vdd_REF, and generates feedback signal FB-1.

At S320, the power regulator unit 133, 213 receives the feedback signal FB-1. At S330, if the feedback signal FB-1 indicates that the voltage Vdd_L is less than a predetermined fraction or percentage of the reference voltage Vdd_REF, the power regulator unit 133, 213 controls the high-side drive 111, 211 and the low-side drive 112, 212 to continue increasing power delivery (S330, “NO” branch). If the feedback signal FB-1 indicates that the voltage Vdd_L equals to or is greater than the predetermined fraction or percentage of the reference voltage Vdd_REF, the power regulator unit 133, 213 controls the high-side drive 111, 211 and the low-side drive 112, 212 to cease increasing power delivery (S330, “YES” branch), and, at S340, switches to receiving the feedback signal FB-2 from the first feedback generation unit 131, 231. The predetermined fraction or percentage of the reference voltage Vdd_REF may be set at any suitable value, e.g. 50%, 80%, 100%, etc. For example, the reference voltage Vdd_REF may be set at 1 V, and the predetermined fraction or percentage may be set at 80%, in which case the power regulator unit 133, 213 would continue to increase the supply voltage Vdd_L until it reaches 0.8 V. The predetermined fraction or percentage may either be fixed or configurable in different embodiments, as desired.

At the time of system start up, no gate delays can be determined as the SoC 130, 230 is yet to reach a fully operational state. Until the supply voltage Vdd_L reaches a required level, the first feedback generation unit 131, 231 cannot generate any meaningful feedback signal FB-2 based on the clock signal of the functional clocks 136, 236. As such, the feedback signal FB-1 from the second feedback generation unit 132, 232 is initially used by the power regulator unit 133, 213 to bring the supply voltage to the required level e.g. 0.8 V. Alternatively, in other embodiments, it may be possible to set the initial supply voltage to the required level using suitable means without a feedback mechanism, if desired. Upon the supply voltage Vdd_L reaches the required level, the first feedback generation unit 131, 231 may begin to use the number of gate delays derived from the clock signal to generate the feedback signal FB-2, and the power regulator unit 133, 213 may switch over to using the feedback signal FB-2 to regulate power delivery. From then on, the power regulator unit 133, 213 may continue to monitor the feedback signal FB-1 generated by the second feedback generation unit 132, 232 e.g. to ensure that the supply voltage does not exceed a maximum level, or simply disregard the feedback signal FB-1.

In particular, the first feedback generation unit 131, 231 compares the current number of gate delays corresponding to (derived from) the current clock signal generated by the functional clock 136, 236 with a target number of gate delays, and generates the feedback signal FB-2 based on the difference. At S350, the power regulator unit 133, 213 receives the feedback signal FB-2. At S360, if the feedback signal FB-2 indicates that the current number of gate delays is lower than the target number of gate delays (S360, “LOWER” branch), the power regulator unit 133, 213 controls the high-side drive 111, 211 and the low-side drive 112, 212 to increase power delivery at S370. If the feedback signal FB-2 indicates that the current number of gate delays is higher than the target number of gate delays (S360, “HIGHER” branch), the power regulator unit 133, 213 controls the high-side drive 111, 211 and the low-side drive 112, 212 to decrease power delivery at S380.

Typically, the speed at which the SoC 130, 230 is required to operate may e.g. depends on the current workload of the SoC or the type of processing to be performed by the SoC, and this in turns determines an optimal number of gate delays per clock cycle (a target number of gate delays) at which the SoC should operate. Varying the voltage Vdd_L of the first supply rail 125, 225 would vary the number of gate delays; however, the precise voltage required to achieve a given number of gate delays may depend on a number of factors, such as the operating temperature of the system, the age (and therefore efficiency) of the system, etc. By varying the supply voltage based directly on the current number of gate delays at which the SoC operates, it is possible to account for different factors that influence the operation of the system to enable more effective power delivery and facilitate improved system performance.

Moreover, digital signals are generally more robust against electrical interference compared to analogue signals. Since the first feedback generation unit (e.g. TDC) uses the digital clock signal from the functional clock to generate a digital feedback signal in the present approach, noise and distortions in the feedback signal are reduced, and voltage regulation may be performed with improved accuracy.

A critical path is the longest path (a path that takes the longest time) in a digital circuit, which determines the minimum clock period or the maximum operating frequency of the digital circuit. A critical path is likely to be complex, consisting of different types of gates and lengths of interconnect between the gates. On the other hand, the first feedback generation unit such as a TDC is likely to consist of a single gate type or a limited choice of selectable gate types with short lengths of interconnect. As the voltage and temperature varies during the operation of the digital circuit, the behaviour of the critical path and the TDC will vary. The relationship between the critical path and the TDC is also dependent on how the semiconductor process parameters (which affect transistor speed and interconnect propagation speed) vary compared to their nominal or expected values (process skew). The relationships between the critical path and the TDC (e.g. as equations) under different operating conditions may be generated, and these relationships may be used as part of the control/feedback mechanism.

Thus, in some embodiments, scaling factor(s) may be determined between data from the first feedback generation unit (TDC) and one or more critical paths in the digital system, and the determined scaling factor(s) may be applied to the current data generated by the first feedback generation unit (TDC) to compensate for process skew.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as VerilogTM or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a "processor", may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term "processor" or "controller" should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. An apparatus for controlling power delivery to one or more digital circuits, the one or more digital circuits having a functional clock unit to provide a clock signal to the one or more digital circuits, the apparatus comprising:
a first feedback generation unit to generate a first feedback signal based on a comparison between a current number of gate delays corresponding to a current clock signal and a target number of gate delays; and
a power regulator unit to adjust the power delivery to the one or more digital circuits based on the first feedback signal.

2. The apparatus of claim 1, wherein the first feedback signal represents a difference between the current number of gate delays and the target number of gate delays, and the power regulator unit is configured to adjust the power delivery to the one or more digital circuits to minimize the difference.

3. The apparatus of claim 2, wherein the power regulator unit adjusts the power delivery to the one or more digital circuits to minimize the difference by increasing the power delivery to the one or more digital circuits when the current number of gate delays is lower than the target number of gate delays, and decreasing the power delivery to the one or more digital circuits when the current number of gate delays is higher than the target number of gate delays.

4. The apparatus of claim 1, further comprising a second feedback generation unit to generate a second feedback signal based on a comparison between a supply voltage of the one or more digital circuits and a reference voltage.

5. The apparatus of claim 4, wherein, upon startup of the digital circuits, the power regulator unit is configured to adjust the power delivery to the one or more digital circuits based on the second feedback signal.

6. The apparatus of claim 5, wherein the power regulator unit is configured to adjust the power delivery to the one or more digital circuits based on the second feedback signal by increasing the power delivery to the one or more digital circuits until the current supply voltage of the one or more digital circuits reaches a predetermined fraction of the reference voltage.

7. The apparatus of claim 6, wherein, upon the current supply voltage reaching the predetermined fraction of the reference voltage, the power regulator unit is configured to switch from the second feedback signal to the first feedback signal.

8. A computer-implemented method of controlling power delivery to one or more digital circuits, the one or more digital circuits having a functional clock unit to provide a clock signal to the one or more digital circuits, the method comprising:
generating a first feedback signal based on a comparison between a current number of gate delays corresponding to a current clock signal and a target number of gate delays; and
adjusting the power delivery to the one or more digital circuits based on the first feedback signal.

9. The method of claim 8, wherein the first feedback signal represents a difference between the current number of gate delays and the target number of gate delays, and the power delivery to the one or more digital circuits is adjusted to minimize the difference.

10. The method of claim 9, wherein the power delivery to the digital circuits is adjusted to minimize the difference by increasing the power delivery to the one or more digital circuits when the current number of gate delays is lower than the target number of gate delays, and decreasing the power delivery to the one or more digital circuits when the current number of gate delays is higher than the target number of gate delays.

11. The method of claim 8, further comprising generating a second feedback signal based on a comparison between a current supply voltage of the one or more digital circuits and a reference voltage.

12. The method of claim 11, further comprising, upon startup of the one or more digital circuits, adjusting the power delivery to the one or more digital circuits based on the second feedback signal.

13. The method of claim 12, wherein the power delivery to the one or more digital circuits is adjusted based on the second feedback signal by increasing the power delivery to the digital circuits until the current supply voltage of the one or more digital circuits reaches a predetermined fraction of the reference voltage.

14. The method of claim 13, further comprising, upon the current supply voltage reaching the predetermined fraction of the reference voltage, switching from the second feedback signal to the first feedback signal.

15. A system comprising:
a system on chip comprising one or more digital circuits and a functional clock unit to provide a clock signal to the one or more digital circuits;
a power stage comprising a power supply circuit to process power delivery to the system on chip;
a first feedback generation unit to generate a first feedback signal based on a comparison between a current number of gate delays corresponding to a current clock signal and a target number of gate delays; and
a power regulator unit to adjust the power delivery to the one or more digital circuits based on the first feedback signal.

16. The system of claim 15, wherein the system on chip comprises the first feedback generation unit and the power regulator unit.

17. The system of claim 15, wherein the system on chip comprises the first feedback generation unit, and the power stage comprises the power regulator unit.

18. The system of claim 15, wherein the first feedback generation unit is a time-to-digital converter.

19. The system of claim 15, wherein the system on chip further comprises a second feedback generation unit to generate a second feedback signal based on a comparison between a current supply voltage of the digital circuits and a reference voltage.

20. The system of claim 19, wherein the second feedback generation unit is a digital comparator, an analogue-to-digital converter, one or more pairs of ring oscillators, or a combination thereof.
